(19) United States
(12) Patent Application Publication
(10) Pub. No.: US 2026/0290180 A1
(43) Pub. Date: Sep. 24, 2026

(54) LEARNING METHOD AND LEARNING SYSTEM

(71) Applicant: KURUME UNIVERSITY, Kurume-shi, Fukuoka (JP)

(72) Inventors: Reiji KATAYAMA, Kurume-shi, Fukuoka (JP); Kei YAMADA, Kurume-shi, Fukuoka (JP); Masaki KASHIHARA, Kurume-shi, Fukuoka (JP)

(73) Assignee: KURUME UNIVERSITY, Kurume-shi, Fukuoka (JP)

(21) Appl. No.: 19/148,778

(22) PCT Filed: Jan. 11, 2024
(86) PCT No.: PCT/JP2024/000462

§ 371 Date: Jul. 17, 2025

(30) Foreign Application Priority Data
Jan. 18, 2023 (JP) 2023-006226

(51) Int. Cl. G09B 5/02; G06T 19/00; G09B 23/30

(52) U.S. Cl. CPC G09B 5/02; G06T 19/006; G09B 23/30; G06T 2210/41

(57) ABSTRACT

Provided are a learning method and a learning system which allow a learner to learn a procedure of a medical operation or treatment to be performed by using a learning target tool with respect to a real human phantom while visually recognizing the virtual expansion of a physical anatomical model projected on the human phantom via a mounted mixed reality display.

A learning system (1) includes a human phantom (2) to be projected, a mixed reality display (3) capable of superimposing and visualizing a first virtual expansion (31) that is a physical anatomical model on a part or all of the human phantom (2) and attachable to a head of a learner (H), and a learning target tool (4) that is a medical tool or an examination tool to be a medical operation learning target.

### TECHNICAL FIELD

The present invention relates to a learning method and a learning system. Specifically, the present invention relates to a technique that allows a learner to learn a procedure of a medical operation or treatment to be performed by using a learning target tool with respect to a real human phantom while visually recognizing the virtual expansion of a physical anatomical model projected on the human phantom via a mounted mixed reality display.

### BACKGROUND ART

Conventionally, in medical learning settings such as the medical department of a university, a high school, a professional school for nursing, etc., learning and training of the human anatomy and a medical operation are performed using a human phantom called a medical simulator, etc. Examples of such human phantoms include those described in Non-Patent Document 1 below.

The human phantom described in Non-Patent Literature 1 is a model including part of the human body (from the lower jaw to the chest and to the right shoulder) in accordance with learning purposes (aims to provide guidance and practical training of medical techniques such as puncture and venous catheter management). The human phantom accurately reproduces the skeleton and the distribution of blood vessels of the model region. This makes it possible to implement practical training from selection of a puncture position to catheter insertion.

On the other hand, in recent years, a learning method by a simulated experience system using virtual reality (VR) has been proposed instead of a human phantom as a substantial object. Examples of such system include those described in Patent Document 1.

A simulated experience system described in Patent Literature 1 includes a video display device, a controller including a main body portion formed in the same or substantially the same shape as a target of education, research, or training and a signal transmission unit that is provided in the main body portion and is capable of transmitting a signal for synchronizing the motion of a to-be-operated object video imitating the target displayed on the video display device with the motion of the main body portion, and a computer including a signal reception unit that is connected to the controller and the video display device and is capable of receiving the signal transmitted from the signal transmission unit, an arithmetic unit that is connected to the signal reception unit and is capable of analyzing the motion of the main body portion based on the received signal and calculating motion data, a video generating unit that is capable of generating the to-be-operated object video based on the shape data of the target, a synchronous processing unit capable of synchronizing the motion data calculated by the arithmetic unit such that the to-be-operated object video generated by the video generating unit moves following the motion of the main body portion, and a video output unit capable of outputting the to-be-operated object video processed by the synchronous processing unit to the video display device.

According to the simulated experience system described in Patent Literature 1, the user's visual sense and tactile sense are stimulated by operating the to-be-operated object video imitating the object displayed on the video display device while touching the main body portion having the same or substantially the same shape as the target for education, etc., and it is possible to obtain a simulated experience that is intuitive and highly immersive.

### CITATION LIST

### Non-Patent Literature

Non-Patent Literature 1: Avice, Inc., human phantom, Medical Model, Medical Simulator, Human Body Dummy Sales, Human Body, Medical/Nursing Simulator KY11347-300 CVC Puncture Insertion Simulator 2 Internet <URL: http://humanbody.jp/simulator/item/ky11347-300.html>

### Patent Literature

Patent Literature 1: Japanese Unexamined Patent Application Publication No. 2020-038272

### SUMMARY OF INVENTION

### Technical Problem

Since the human phantom described in Non-Patent Literature 1, which is an existing technology, is a substantial object, there is a sense of reality and a tactile sensation at the time of using for learning, and the human phantom is suitable for checking a procedure at the time of using the learning target tool. However, the human phantom is often a model of a part of the human body in accordance with the learning purpose. £ In addition, ordinary human phantoms do not include the peripheral human anatomy other than the learning purpose in the structure of the phantom. Therefore, it is impossible or inappropriate to use the human phantom other than the learning purpose. In addition, although there human phantoms of whole body models, such human phantoms are expensive as compared with a model of a part of the human body. In addition, such human phantoms have inconsistencies in structural details between a portion having a precise structure and a portion having a less detailed structure. Therefore, it cannot be said that these human phantoms are suitable for general-purpose use.

On the other hand, according to the simulated experience system described in Patent Literature 1, learning can be performed while visually recognizing an object such as an organ displayed on a video display device and touching a controller designed to resemble the object, but the object is merely non-physical virtual reality. That is, since there is no substantial object like a human phantom to which the learning target tool is applied, the simulated experience system is not suitable for practical training such as a medical operation or procedure check using the learning target tool.

The present invention has been made in view of the above points and has an object to provide a learning method and a learning system that enables a learner to learn a procedure of a medical operation or treatment to be performed by using a learning target tool with respect to a real human phantom while visually recognizing the virtual expansion of a physical anatomical model projected on the human phantom via a mounted mixed reality display.

### Solution to Problem

In order to achieve the above object, a learning method according to the present invention is performed by using a human phantom to be projected, a mixed reality display capable of superimposing and visualizing a first virtual expansion that is a physical anatomical model on a part or all of the human phantom, and a learning target tool that is a medical tool or an examination tool as a medical operation learning target. The method includes a first step of causing a learner to wear the mixed reality display and visually recognize the human phantom and the first virtual expansion projected on the human phantom via the mixed reality display and a second step of causing the learner who has undergone the first step to take the learning target tool by hand and apply the learning target tool to the human phantom while visually recognizing the human phantom and the first virtual expansion and learn a procedure of a medical operation or treatment to be performed.

Here, in the first step, preliminary preparation is completed by the learner wearing the mixed reality display, and then, the learner can visually recognize the human phantom and the first virtual expansion projected on the human phantom via the mixed reality display.

Note that the term “learner” is used in the sense of including not only pre-employment students such as those in medical schools, nursing schools, and professional schools aiming at medical professionals, but also those who have already become medical professionals. For example, a recent graduate from a medical school, etc., may perform training to become proficient with a tool, etc., of a type different from the tool used in the school or may perform training more practical than school education. In addition, even a student already graduated from a medical school, etc., may perform training as continuous learning to become proficient with a newly introduced tool, etc., or a new practice method or further technical improvement, and thus, such individuals are also included in the category of “learner.” The learning method according to the present invention is essentially used by a learner but does not exclude an instructor (a person who implements the present invention as a model in the description before and after learning) from the “learner.”

Examples the “first virtual expansion” include an image of an organ or a bone of a person, and projecting the image of the organ, etc., to an appropriate portion of the human phantom makes it possible to enhance a sense of immersion in learning. In addition, a learner can confirm the position of the organ, etc., in advance. Further, the “first virtual expansion” includes not only a single image of a human organ, etc., but also an image projected in a mode (superimposed mode) of superimposing a plurality of images. As an example of the projection in the superimposed mode, there is a mode in which an image of a bone and an image of an organ (located below the image of the same bone) are projected in a superimposed manner. In this case, more practical learning can be performed while referring to the arrangement of a plurality of projected images.

The data of the image projected by the “first virtual expansion” may be installed in the mixed reality display or stored in an auxiliary storage device connected to a device body or may be received from an external device such as a server connected to the mixed reality display in a wired or wireless manner. Furthermore, the image processing regarding the “first virtual expansion” may be performed by a function included in the mixed reality display or may be performed by receiving data processed by an external device such as a server connected to the mixed reality display by a wireless manner, etc.

Note that the mixed reality display can project the first virtual expansion even on a portion having no physical object (a non-physical portion; which can also be regarded as a space) of the human phantom. For example, in a case where the physical human phantom in front of the eyes is only the torso, by superimposing and visualizing the first virtual expansion of the head, the lower limb, the arm, etc., which are non-physical portions, on the human phantom in three dimensions, it is possible to express as if the head and other parts were added to the human phantom and really existed. Further, it is possible to switch between display and non-display of the non-physical portion as necessary. That is, according to the mixed reality display, it is possible to perform various kinds of learning without possessing a plurality of human phantoms, and it is possible to expect improvement in learning efficiency and effect by switching between display and non-display of a non-physical portion. It is also possible to reduce introduction and operation costs associated with the possession of a plurality of human phantoms.

Then, in the second step, when learning a procedure of a medical operation or treatment, the learner can hold the learning target tool used for an actual operation or examination, etc., and apply the learning target tool to the human phantom on which the first virtual expansion is projected.

As a result, the learner visually obtains a realistic feeling as if facing a patient, etc., and applies the learning target tool to the human phantom by holding the actual learning target tool instead of an intangible virtual image, so that a response close to actual work can be obtained tactilely. Accordingly, since the learner receives visual and tactile stimuli (in other words, real visual sense and tactile sense) as if a treatment, etc., is performed on a patient, etc., in an actual site, a high learning effect can be expected.

Among the “learning target tools,” medical tools include, for example, a puncture needle, a tube for drainage, a suture needle, a syringe, forceps, medical cutlery such as a scalpel, and a plate and a pin, etc., used for fracture treatment, and examination tools include, for example, a probe in an ultrasonic diagnostic apparatus, electrodes of an electrocardiogram measuring device, and an endoscope. Note that the medical tools and the examination tools described above are merely examples, and it goes without saying that various tools can be targets.

By the way, it is common to prepare various types of human phantoms according to examined portions and cases at the time of conventional learning that was performed for an operation or examination. When a plurality of human phantoms are prepared, the burden associated with a procurement cost is large, and a large storage space is required at the time of non-use. In contrast to this, with the learning method according to the present invention, the content of the first virtual expansion to be projected on the mixed reality display can be changed, and hence projecting various images and videos (first virtual expansion) on one human phantom makes it possible to obtain an effect similar to that of actually possessing a plurality of human phantoms. That is, with the learning method according to the present invention, the burden associated with a procurement cost is small, and a storage space at the time of non-use is small as compared with the conventional learning method.

Furthermore, according to the learning method of the present invention, the mixed reality display can project the first virtual expansion even on a portion having no physical object (a non-physical portion; which can also be regarded as a space) of the human phantom. For example, in a case where the physical human phantom in front of the eyes is only the torso, by superimposing and visualizing the first virtual expansion of the head, the lower limb, the arm, etc., which are non-physical portions, on the human phantom in three dimensions, it is possible to express as if the head and other parts were added to the human phantom and really existed. Further, it is possible to switch between display and non-display of the non-physical portion as necessary. That is, with the learning method according to the present invention, the mixed reality display makes it possible to perform various kinds of learning without possessing a plurality of human phantoms and to expect improvement in learning efficiency and effect by switching between display and non-display of a non-physical portion. It is also possible to reduce introduction and operation costs associated with the possession of a plurality of human phantoms.

Further, in the learning method described above, the mixed reality display may be capable of superimposing and visualizing a second virtual expansion that is an expression model of a patient role with respect to a face portion of the human phantom, in the first step and the second step, the second virtual expansion is applied to the human phantom, and at least in the second step, the learner may perform learning while visually recognizing the expression model of the patient role projected by the second virtual expansion as needed or perform learning while visually recognizing the expression model of the patient role as needed and also engaging in conversation according to a situation.

With the learning method according to the present aspect, in at least the second step, the second virtual expansion is visualized (applied) in a superimposed manner to the face portion of the human phantom, so that the learner can perform learning while visually recognizing the expression model of the patient role projected by the second virtual expansion as needed or can perform learning while visually recognizing the expression model of the patient role as needed and also engaging in conversation according to the situation.

That is, with the learning method according to the present aspect, it is possible to perform training of a procedure of a medical operation or treatment to be performed as if the procedure or treatment is performed for an actual patient without preparing an actual patient or a patient role (in other words, even though the learner is merely interacting with the human phantom), and it is possible to expect an even higher learning effect by receiving a visual stimulus as if a learner is performing treatment, etc., on the patient, etc., in an actual site (in other words, it is possible to have a realistic sense).

Note that the application of the second virtual expansion to the human phantom may be applied not only in the second step but also in the first step. In this case, it is possible not only to acquire a technique that is directly related to a case but also to perform training of observing a change in the expression of the patient due to a sudden change in the disease state before the start of a medical operation or engaging in conversation for alleviating the anxiety or tension of the patient.

Furthermore, the expression model of the patient role expressed by the second virtual expansion may be, for example, a typical model set in advance in the mixed reality display or may be an educational guidance teacher or a fellow learner who receives guidance together. When the educational guidance teacher or the fellow learner is used as the expression model of the patient role, a sense of tension is provided in learning and a high learning effect can be expected (on the other hand, there is a possibility that a high learning effect can also be expected under a relaxed atmosphere by providing humor).

Furthermore, in a case where an educational guidance teacher or a fellow learner is used as an expression model of a patient role, a real-time expression captured by a camera may be displayed using video processing software. Further, settings may be made to concurrently generate sound such as “ouch!” in accordance with the expression of the typical model of the patient role expressed by the second virtual expansion. In a case where an educational guidance teacher or a fellow learner is served as the real-time expression model of the patient role, it is possible to perform training in adaptive responses by setting the model and the learner to be able to engage in conversation with each other.

In addition, according to the learning method described above, in the expression model visualized by the second virtual expansion, an eyeline may be set to be movable in a direction of the learner in a timely manner of at least a depiction related to an eye, and the eyeline may also be set to be recognizable by the learner via the mixed reality display.

With the learning method according to the present aspect, when the learner performs learning, etc., while visually recognizing the expression model of the patient role projected by the second virtual expansion as needed, the eyeline of the patient role can be changed, and the learner can also recognize the change.

An actual patient or a person to be examined may look at the face (expression) of a practitioner (such as a doctor or an examination technician) when feeling anxiety or pain. That is, with the learning method according to the present aspect, at least the eyeline of the expression model applied to the human phantom and visualized moves in the direction of the learner in a timely manner (in other words, the eyeline faces the learner), so that the learner can feel a sense of tension and a sense of reality close to an actual operation, and further improvement of the learning effect can be expected.

In the learning method according to the present aspect, examples of the timely movement of the eyeline include, for example, a mode that is a typical operation set (programmed) in advance in the mixed reality display. However, the present invention is not limited to this, and the learning method may include a mode in which an educational guidance teacher or a fellow learner observing the training situation of a learner performs an operation of intentionally moving the eyeline using software, etc., and a mode in which a pressure-sensitive sensor or a pressure sensor provided in a human phantom is linked to software, etc., of the mixed reality display, and the eyeline is set to move in the direction of the learner in a timely manner when a predetermined pressure is sensed. Furthermore, in the case of a mode linked to a pressure-sensitive sensor, etc., provided in the human phantom, setting may be made such that the eyeline is moved in various ways including the presence or absence of movement itself or movement with time differences in accordance with the magnitude of a detected pressure.

Note that, also in the learning method according to the present aspect, the second virtual expansion may be applied to the human phantom not only in the second step but also in the first step. Furthermore, the expression model in the learning method according to the present aspect may also be a typical model set in advance in the mixed reality display or may be an educational guidance teacher, a fellow learner, etc.

Furthermore, in the learning method described above, the first virtual expansion may be provided so that a medical image and a three-dimensional anatomical image which are set to appropriate sizes to be fitted to the human phantom can be superimposed on the same screen.

Note that, in this case, the “medical image” includes a two-dimensional computed tomography image (hereinafter referred to as “two-dimensional CT image”), a magnetic resonance image (hereinafter referred to as “two-dimensional MRI image ”), an ultrasonic image (hereinafter referred to as “echo image”), an X-ray photography image (hereinafter referred to as “X-ray image”), a radioactive medicine image (hereinafter referred to as “RI image”), etc., and does not exclude other types of medical images.

Conventionally, in a medical setting such as actual medical care, observation with a medical image (for example, a two-dimensional CT image or a two-dimensional MRI image) in full size has not been performed, and there is no environment in which the above-described two-dimensional medical image and three-dimensional anatomical image can be learned in full size stereoscopically. Therefore, many students and inexperienced practitioners (doctors and examination technicians) have had difficulty in understanding the relationship between the two-dimensional medical image and the three-dimensional anatomical image.

However, with the learning method according to the present aspect, the learner can learn while visually recognizing the stereoscopic full-size medical image and the three-dimensional anatomical image projected by being superimposed by the first virtual expansion as needed. That is, it is possible to learn the spatial positional relationship between a medical image (particularly, a two-dimensional image) and a three-dimensional anatomical image (three-dimensional image) in association with each other, and thus, it is possible to perform training for understanding the relationship between a medical image and a three-dimensional anatomical image, with which many students and inexperienced practitioners (doctors and examination technicians) have been struggling and to further deepen understanding. This makes it possible to expect further improvement of a learning effect. Then, the understanding of the relationship between the medical image and the three-dimensional anatomical image by the learner is deepened, and hence it is expected that the learner (that is, a future practitioner) will eventually be able to intuitively understand the position of the organ, etc., only by viewing the medical image (the two-dimensional medical image in particular).

In the learning method according to the present aspect, examples of a medical image and a three-dimensional anatomical image include a mode which are healthy standard images, but the present invention is not limited to this. The method may include a mode in which the medical image and the three-dimensional anatomical image are images of organs, bones, etc., of a patient or an individual having a lesion or a specific feature, or a mode in which the medical image and the three-dimensional anatomical image are used as the three-dimensional anatomical images constructed based on a captured medical image of an individual and the medical image, etc. In a case where an image of an organ, a bone, etc., of a patient having a lesion is applied, not only the learner but also a medical worker including a doctor can use the image for consideration of an operation plan before actual surgery or treatment or for a pre-operative meeting.

“A medical image and a three-dimensional anatomical image can be superimposed on the same screen” means that the medical image and the three-dimensional anatomical image only need to be superimposed on the same screen and includes both a mode in which the medical image and the three-dimensional anatomical image are simultaneously overlapped and displayed and a mode in which the medical image and the three-dimensional anatomical image are alternately displayed at the same position by switching.

Furthermore, in the learning method described above, the human phantom may be applied to a pseudo structure in which any one of skin, muscle, bone, blood vessel, membrane, and organ is reproduced to at least a predetermined portion to be learned, or may be applied to a plurality of these pseudo structures in combination.

With the learning method according to the present aspect, when the learning target tool is applied to the human phantom in the training simulating an examination or treatment, the pseudo structure reproducing skin, etc., is applied to the site where the examination or treatment is performed, so that a response closer to the human body can be obtained tactilely. As a result, the learner receives a tactile stimulus as if a treatment, etc., is performed on a patient, etc., in an actual site (in other words, can obtain a realistic tactile sense) and can expect a higher learning effect.

The human phantom may be configured such that a combination of a plurality of pseudo structures of skin, muscle, bone, blood vessel, membrane, and organ is applied to a predetermined portion to be learned. For example, in a case where skin, bone, and a target organ are selected as pseudo structures, and these are provided in a superimposed manner (in a laminated manner), in the training of the operation of puncturing the target organ, the learner can learn palpation of a space between bones, the degree of force passing through the skin, the operation of penetrating the space between the bones by a needle, and the adjustment of force or depth for bringing the needle to the target organ by actual tactile sensation. Furthermore, when pseudo structures of muscle, membrane, and blood vessel are applied, it is also possible to feel resistance of the muscle or the membrane at the time of puncture and to learn a medical operation for puncturing between the muscle fibers and the blood vessels so as not to damage them.

Note that the application place of a pseudo structure is “at least to a predetermined portion to be learned,” but a mode in which the above-described pseudo structures are applied to not only a part of the human phantom but also the entire human phantom may be adopted. In a case where the above-described pseudo structures are applied to the entire human phantom, the structures become complicated, but one human phantom can cope with training of various examinations and operations. This provides greater convenience and further improves versatility.

Furthermore, in the learning method described above, the pseudo structures may use a soft material for skin, muscles, blood vessels, membranes, and organs and use a semi-hard material or a hard material for bones.

With the learning method according to the present aspect, when the learning target tool is applied to the human phantom in the training simulating an examination or treatment described above, the pseudo structure formed of a material with hardness corresponding to a site to be examined or treated is applied, so that a response closer to the human body can be obtained tactilely. As a result, the learner receives a tactile stimulus as if a treatment, etc., is performed on a patient, etc., in an actual site (in other words, can obtain a realistic tactile sense) and can expect an even higher learning effect.

Note that, as the “soft material,” a material such as a resin or rubber having hardness close to that of target skin, muscles, blood vessels, membranes, or organs is suitably used. As the “hard material,” a material such as a resin, rubber, stone, or metal having hardness close to that of a target bone is suitably used. Alternatively, a semi-hard material such as a resin or rubber prepared to be hard may be used for reproducing cartilage.

Furthermore, in the learning method described above, the human phantom and the learning target tool may be provided with a position sensor and a pressure-sensitive sensor or a pressure sensor, and the second virtual expansion may be set to change to an expression expressing discomfort or suffering when both or any one of position information detected by the position sensor and a pressure value detected by the pressure-sensitive sensor or the pressure sensor exceeds a preset set value.

With the learning method according to the present aspect, in the training simulating the examination and treatment described above, when the learning target tool is applied to the human phantom, in the case where an operation is performed in a way that would cause pain if performed on an actual human, the expression model represented by the second virtual expansion changes to an expression expressing discomfort or suffering. Therefore, it is possible to immediately determine that an inappropriate operation has been performed by the learner himself/herself, and it is also possible to perform training of an operation while checking an expression (while visually recognizing the expression) in the same manner as performing an operation on an actual human.

Note that whether or not a given treatment is one that makes a human body feel a pain sensation is determined based on whether or not both or any one of the position information and the pressure value, provided in the human phantom and the learning target tool, detected by the position sensor and the pressure-sensitive sensor the pressure sensor exceeds a preset set value.

For example, assume that the position information related to the puncture depth is transmitted by the position sensor provided in a needle as the learning target tool, and the position information directly received by the mixed reality display or indirectly received by the mixed reality display via the external device that analyzes the position information is inappropriate (for example, the puncture position is too deep). In this case, the expression model represented by the second virtual expansion displayed on the mixed reality display changes to the expression expressing discomfort or suffering. Furthermore, for example, assume that a pressure-sensitive sensor or a pressure sensor is provided in a predetermined portion to be learned in the human phantom, and a pressure value is transmitted by the pressure-sensitive sensor, etc., provided in the human phantom at the time of training of pressing examination equipment (for example, a probe, etc., in an ultrasonic diagnostic apparatus) which is a learning target tool against the predetermined portion, and the pressure value directly received by the mixed reality display or the pressure value indirectly received by the mixed reality display via an external device that analyzes the pressure value is inappropriate (for example, the pressing force is too strong). In this case, the expression model represented by the second virtual expansion displayed on the mixed reality display changes to an expression expressing discomfort or suffering.

In addition, together with the above settings, settings may be made to concurrently generate sound such as “ouch!” in accordance with a change to an expression expressing discomfort or suffering. In this case, the sense of realism is further increased, and training can be performed with a sense of tension.

Furthermore, in the learning method described above, the human phantom may be provided with a camera capable of capturing the learner at a position of an eye portion for a human phantom having a head or at a position corresponding to an eye portion for a human phantom having no head.

With the learning method according to the present aspect, it is possible to capture a video at an eyeline (in other words, a video captured from the human phantom side) of observing the learner during training (learning) simulating an examination or treatment, and obtain the video. That is, the learner can objectively observe the expressions and actions of the practitioner as viewed from the patient, etc., at the time of an actual operation. In addition, the learner can also feel the psychological state of the patient, etc., such as how the practitioner is viewed from the patient, etc. Accordingly, the learner can learn both the practitioner side and the patient side in one training session.

Note that the “camera” described above may be provided so as to be able to capture the learner. If, however, for example, the camera has a fixed structure, it is preferable that the angle of view is wide. In addition, the camera may have a movable structure. Examples of the movable structure include a structure in which a head or an eye portion (including a portion at a position corresponding to the eye portion) can be manually, automatically, or remotely operated to face the direction of the learner and capture the learner.

In addition, the video captured by the camera described above may be displayed in real time on the mixed reality display worn by the learner or may be recorded on a hard disk, etc., of a personal computer (hereinafter referred to as “PC”) connected to the mixed reality display. The mode of displaying a video on the mixed reality display in real time may be, for example, a mode of displaying a video on a sub-window opened on a side of a video of the human phantom viewed by the learner or a mode of displaying a video on the entire screen by appropriately switching from the video of the human phantom viewed by the learner. In addition, in the case of the mode of recording data on a hard disk, etc., of a PC, for example, a learner, etc., can check the data on another monitor, etc., after training (learning). Furthermore, the captured video may be simultaneously output to a large monitor. In this case, a standby learner other than the learner who is being trained (learned) can also share the video, and the standby learner who starts the training next can easily understand the perspective and the state of mind on the patient side, so that the learning efficiency of the entire learner group can be expected to be improved.

Furthermore, in the learning method described above, the human phantom may be installed in an indoor space available as a teaching room, the mixed reality display may be capable of superimposing and visualizing a third virtual expansion that is an examination device and/or a therapy device model in the indoor space, and in both or one of the first step and the second step, the learner learns a treatment or procedure to be performed while visually recognizing the third virtual expansion projected in the indoor space via the mixed reality display.

Note that the expression “examination device and/or therapy device” used in the present aspect includes both the examination device and the therapy device and only one of the examination device and the therapy device.

With the learning method according to the present aspect, by visually recognizing the third virtual expansion projected in the indoor space via the mixed reality display, the indoor space can be regarded as an examination room or a treatment room, and the human phantom installed therein can also be regarded as a subject to be examined, treated, etc., to perform learning.

At this time, in both or one of the first step and the second step, the learner may learn a treatment or procedure to be performed while further visually recognizing the third virtual expansion projected on the indoor space via the mixed reality display. For example, while viewing the image of the third virtual expansion (examination device model, etc.) projected in the indoor space, the learner can perform learning or training of a preparation or check procedure, etc., of an examination device, etc., before the start and can also perform learning or training of the learner's maneuvers and movements according to the positions of the examination device and the human phantom after the start.

Examples of the image projected by the third virtual expansion include a magnetic resonance imaging (MRI) examination device, a computed tomography (CT) examination device, an X-ray examination device, a radiation therapy device, a proton therapy device, an endoscope device (an endoscope and a surgical tool used with the endoscope), etc., and it is also possible to perform learning and training of movement of a learner, such as moving a human phantom with respect to the examination device, etc., projected by the virtual expansion, or moving an arm portion of the examination device projected by the virtual expansion and applying the arm portion to the human phantom.

That is, with the learning method according to the present aspect, it is possible to perform training of a procedure of a medical operation or treatment to be performed as if the procedure or treatment is performed for a patient in a space where the actual examination device or therapy device exists without preparing an actual examination device or therapy device, and it is possible to expect an even higher learning effect by receiving a visual stimulus as if a learner is performing treatment, etc., on the patient, etc., in an actual site (in other words, obtaining a realistic visual sensation).

In order to achieve the above object, a learning system of the present invention includes a human phantom to be projected, a mixed reality display capable of superimposing and visualizing a first virtual expansion that is a physical anatomical model on a part or all of the human phantom and attachable to a head of the learner, and a learning target tool that is a medical tool or an examination tool to be a medical operation learning target.

Here, by wearing the mixed reality display, the learner can visually recognize the human phantom and the first virtual expansion projected on the human phantom via the mixed reality display. Then, when learning a procedure of a medical operation or treatment, the learner can hold the learning target tool used for an actual operation, examination, etc., and apply the learning target tool to the human phantom on which the first virtual expansion is projected.

As a result, the learner visually obtains a realistic feeling and an immersive feeling as if facing a patient, etc., and applies the learning target tool to the human phantom by holding the actual learning target tool instead of an intangible virtual image, so that a response close to actual work can be obtained tactilely. Accordingly, since the learner receives visual and tactile stimuli (in other words, real visual sense and tactile sense) as if a treatment, etc., is performed on a patient, etc., in an actual site, a high learning effect can be expected.

The “human phantom” only needs to be a projection target of the first virtual expansion described above, and for example, a full-size object such as a so-called practical training model doll, etc., is suitably used. In addition, as will be described later, since the mixed reality display can project the first virtual expansion also on the non-physical portion of the human phantom, the human phantom does not necessarily have the entire body size and may have a form including only a portion particularly necessary for learning (for example, only a torso without the upper limb, the lower limb, and the head).

The “learning target tool” only needs to be a medical tool or an examination tool as a medical operation learning target and can be various tools. Examples of the medical tool include, for example, a needle, a tube, and medical cutlery such as a scalpel, and examples of the examination tool include, for example, a probe in an ultrasonic diagnostic apparatus, electrodes of an electrocardiogram measuring device, etc.

The “mixed reality display” only needs to have a function of visualizing the first virtual expansion, which is a physical anatomical model, in a superimposed manner with respect to at least a part or the whole of the human phantom and has a structure that can be attached to the head of the learner, and a head mounted display (goggles, glasses, helmet, etc.,) capable of implementing a so-called extended reality (XR) technology is used. Note that, among the extended reality (XR) technologies, the mixed reality (MR) technology having a high integration performance between the human phantom and the first virtual expansion and excellent three-dimensional representation is preferably used, but the present invention is not limited thereto. For example, augmented reality (AR) technology can also be used and is not excluded.

Examples of the “first virtual expansion” include an image of an organ or a bone of a person, and projecting the image of the organ, etc., to an appropriate portion of the human phantom makes it possible to enhance a sense of immersion in learning. In addition, a learner can confirm the position of the organ, etc., in advance. Further, the “first virtual expansion” includes not only a single image of a human organ, etc., but also an image projected in a mode (superimposed mode) of superimposing a plurality of images. As an example of the projection in the superimposed mode, there is a mode in which an image of a bone and an image of an organ (located below the image of the same bone) are projected in a superimposed manner. In this case, more practical learning can be performed while referring to the arrangement of a plurality of projected images.

The data of the image projected by the “first virtual expansion” may be installed in the mixed reality display or stored in an auxiliary storage device connected to a device body or may be received from an external device such as a server connected to the mixed reality display in a wired or wireless manner. Furthermore, the image processing regarding the “first virtual expansion” may be performed by a function included in the mixed reality display or may be performed by receiving data processed by an external device such as a server connected to the mixed reality display by a wireless manner, etc.

That is, with the learning system according to the present invention, the content of the first virtual expansion to be projected on the mixed reality display can be changed, and if various images and videos (first virtual expansion) are projected on one human phantom, an effect similar to that of actually possessing a plurality of human phantoms can be obtained. Therefore, the burden associated with the procurement cost is small and a storage space at the time of non-use is small as compared with the above-described conventional system that was used for learning of an operation or examination.

Furthermore, with the learning system according to the present invention, since the mixed reality display can project the first virtual expansion also on the non-physical portion of the human phantom, it is possible to express as if the non-physical portion projected by the first virtual expansion is added to the human phantom and really existed. Further, it is possible to switch between display and non-display of the non-physical portion as necessary. That is, with the learning system according to the present invention, the mixed reality display makes it possible to perform various kinds of learning without possessing a plurality of human phantoms and to expect improvement in learning efficiency and effect by switching between display and non-display of a non-physical portion. It is also possible to reduce introduction and operation costs associated with the possession of a plurality of human phantoms.

Furthermore, in the learning system described above, the mixed reality display may be set so that a second virtual expansion which is an expression model of a patient role can be visualized in a superimposed manner with respect to a face portion of the human phantom.

With the learning system according to the present aspect, the second virtual expansion can be visualized (applied) in a superimposed manner to the face portion of the human phantom. As a result, the learner can perform learning while visually recognizing the expression model of the patient role projected by the second virtual expansion as needed or can perform learning while visually recognizing the expression model of the patient role as needed and also engaging in conversation according to the situation. Furthermore, in this learning according to this case, it is possible not only to acquire a technique that is directly related to a case but also to perform training of observing a change in the expression of the patient due to a sudden change in the disease state before the start of a medical operation or engaging in conversation for alleviating the anxiety or tension of the patient.

Then, with the learning system according to the present aspect, it is possible to perform training of a procedure of a medical operation or treatment to be performed as if the procedure or treatment is performed for an actual patient without preparing an actual patient or a patient role, and it is possible to expect an even higher learning effect by receiving a visual stimulus as if a learner is performing treatment, etc., on the patient, etc., in an actual site.

Note that the expression model of the patient role expressed by the second virtual expansion may be a typical model or a fellow learner as described above, and in the case of the fellow learner, the real-time expression processed by video processing software may be displayed. In addition, as described above, the above setting may be used in combination with the setting in which a sound is generated according to the expression of the typical model expressed by the second virtual expansion, and in a case where the fellow learner is used as an expression model, the model and the learner may be set to be able to converse with each other, allowing the learner to perform training in adaptive responses.

Furthermore, in the learning system described above, in the expression model visualized by the second virtual expansion, an eyeline may be set to be movable in a direction of the learner in a timely manner of at least a depiction related to an eye, and the eyeline may also be set to be recognizable by the learner via the mixed reality display.

With the learning system according to the present aspect, when the learner performs learning, etc., while visually recognizing the expression model of the patient role projected by the second virtual expansion as needed, the eyeline of the patient role can be changed, and the learner can also recognize the change.

An actual patient or a person to be examined may look at the face of the practitioner when feeling anxiety or pain. That is, with the learning method according to the present aspect, at least the eyeline of the expression model applied to the human phantom and visualized moves in the direction of the learner in a timely manner, that the learner can feel a sense of tension and a sense of reality close to an actual operation, and further improvement of the learning effect can be expected.

In the learning system according to the present aspect, examples of the timely movement of the eyeline include, for example, a mode that is a typical operation set in advance in the mixed reality display, a mode in which an educational guidance teacher, etc., observing the training situation of the learner performs an operation of intentionally moving the eyeline using software, etc., a mode in which a pressure-sensitive sensor, etc., provided in a human phantom is linked to software, etc., of the mixed reality display, and the eyeline is set to move in the direction of the learner in a timely manner when a predetermined pressure is sensed, etc. Furthermore, in the case of a mode linked to a pressure-sensitive sensor, etc., provided in the human phantom, setting may be made such that the eyeline is moved in various ways including the presence or absence of movement itself or movement with time differences in accordance with the magnitude of a detected pressure.

Note that, also in the learning system according to the present aspect, the second virtual expansion may be applied to the human phantom not only in the second step but also in the first step. Furthermore, the expression model in the learning system according to the present aspect may also be a typical model set in advance in the mixed reality display or may be an educational guidance teacher, a fellow learner, etc.

Furthermore, in the learning system described above, the first virtual expansion is provided so that a medical image and a three-dimensional anatomical image which are set to appropriate sizes to be fitted to the human phantom can be superimposed on the same screen. In this case, the “medical image” means to include the above-described two-dimensional CT image, etc., and does not exclude other types of medical images.

With the learning system according to the present aspect, the learner can learn while visually recognizing the stereoscopic full-size medical image and the three-dimensional anatomical image projected by being superimposed by the first virtual expansion as needed. That is, it is possible to learn the spatial positional relationship between a medical image (particularly, a two-dimensional image) and a three-dimensional anatomical image (three-dimensional image) in association with each other on the same screen, and thus, it is possible to perform training for understanding the relationship between a medical image and a three-dimensional anatomical image, with which many students and inexperienced practitioners have been struggling and to further deepen understanding. This makes it possible to expect further improvement of a learning effect. Then, the understanding of the relationship between the medical image and the three-dimensional anatomical image by the learner is deepened, and hence it is expected that the learner will eventually be able to intuitively understand the position of the organ, etc., only by viewing the medical image (the two-dimensional medical image in particular).

“A medical image and a three-dimensional anatomical image can be superimposed on the same screen” means that the medical image and the three-dimensional anatomical image only need to be superimposed on the same screen and includes both a mode in which the medical image and the three-dimensional anatomical image are simultaneously overlapped and displayed and a mode in which the medical image and the three-dimensional anatomical image are alternately displayed at the same position by switching.

In the learning system according to the present aspect, examples of a medical image and a three-dimensional anatomical image include a mode which are healthy standard images. The system also includes a mode in which the medical image and the three-dimensional anatomical image are images of organs, bones, etc., of a patient or an individual having a lesion or a specific feature, a mode in which the medical image and the three-dimensional anatomical image are used as the three-dimensional anatomical images constructed based on a captured medical image of an individual and the medical image, etc. Then, in a case where an image of an organ, a bone, etc., of a patient having a lesion is applied, not only the learner but also a medical worker including a doctor can use the image for consideration of an operation plan before actual surgery or treatment or for a pre-operative meeting.

Furthermore, in the learning system described above, the human phantom and the learning target tool are provided with a position sensor and a pressure-sensitive sensor or a pressure sensor, and the mixed reality display has a reception function capable of receiving position information detected by the position sensor and a pressure value detected by the pressure-sensitive sensor or the pressure sensor and a set value storage function, and is set such that the second virtual expansion changes to an expression expressing discomfort or suffering when both or one of the position information and the pressure value received by the reception function exceeds a preset set value.

With the learning system according to the present aspect, when the learning target tool is applied to the human phantom in the training simulating the examination and treatment described above, the expression model represented by the second virtual expansion changes to an expression expressing discomfort or suffering in the case where an operation is performed in a way that would cause pain if performed on an actual human. As a result, it is possible to immediately determine that an inappropriate operation has been performed by the learner himself/herself, and it is also possible to perform training of an operation while checking the expression in the same manner as performing an operation on an actual person.

Note that whether or not a given treatment is one that makes a human body feel a pain sensation is determined based on whether or not both or any one of the position information and the pressure value, provided in the human phantom and the learning target tool, detected by the position sensor and the pressure-sensitive sensor or the pressure sensor exceeds a preset set value.

For example, assume that the position information related to the puncture depth is transmitted by the position sensor provided in a needle as the learning target tool, and the position information directly received by the mixed reality display or indirectly received by the mixed reality display via the external device that analyzes the position information is inappropriate. In this case, the expression model represented by the second virtual expansion displayed on the mixed reality display changes to the expression expressing discomfort or suffering. Furthermore, for example, assume that a pressure-sensitive sensor or a pressure sensor is provided in a predetermined portion to be learned in the human phantom, and a pressure value is transmitted by the pressure-sensitive sensor, etc., provided in the human phantom at the time of training of pressing examination equipment which is a learning target tool against the predetermined portion, and the pressure value directly received by the mixed reality display or the pressure value indirectly received by the mixed reality display via an external device that analyzes the pressure value is inappropriate. In this case, the expression model represented by the second virtual expansion displayed on the mixed reality display changes to an expression expressing discomfort or suffering. In addition, together with the above settings, settings may be made to concurrently generate sound in accordance with a change to an expression expressing discomfort or suffering. In this case, the sense of realism is further increased, and training can be performed with a sense of tension.

Furthermore, in the learning system described above, the human phantom may be applied to a pseudo structure in which any one of skin, muscle, bone, blood vessel, membrane, and organ is reproduced to at least a predetermined portion to be learned, or may be applied to a plurality of these pseudo structures in combination.

With the learning system according to the present aspect, when the learning target tool is applied to the human phantom in the training simulating an examination or treatment, the pseudo structure reproducing skin, etc., is applied to the site where the examination or treatment is performed, so that a response closer to the human body can be obtained tactilely. As a result, the learner receives a tactile stimulus as if a treatment, etc., is performed on a patient, etc., in an actual site and can expect a higher learning effect.

The human phantom may be configured such that a combination of a plurality of pseudo structures of skin, muscle, bone, blood vessel, membrane, and organ is applied to a predetermined portion to be learned. For example, in a case where skin, bone, and a target organ are selected as pseudo structures, and these are provided in a superimposed manner, in the training of the operation of puncturing the target organ, the learner can learn palpation of a space between bones, the degree of force passing through the skin, the operation of penetrating the space between the bones by a needle, and the adjustment of force or depth for bringing the needle to the target organ by actual tactile sensation. Furthermore, when pseudo structures of muscle, membrane, and blood vessel are applied, it is also possible to feel resistance of the muscle or the membrane at the time of puncture and to learn a medical operation for puncturing between the muscle fibers and the blood vessels so as not to damage them.

Note that the mode concerning the application place of the pseudo structure may be a mode in which the above-described pseudo structure is applied not only to a part of the human phantom but also to the entire human phantom. In this case, the structure becomes complicated, but one human phantom can cope with training of various examinations and operations. This provides greater convenience and further improves versatility.

Furthermore, in the learning system described above, the pseudo structures may use a soft material for skin, muscles, blood vessels, membranes, and organs and use a semi-hard material or a hard material for bones.

With the learning system according to the present aspect, when the learning target tool is applied to the human phantom in the training simulating an examination or treatment described above, the pseudo structure formed of a material with hardness corresponding to a site to be examined or treated is applied, so that a response closer to the human body can be obtained tactilely. As a result, the learner receives a tactile stimulus as if a treatment, etc., is performed on a patient, etc., in an actual site and can expect an even higher learning effect.

Furthermore, in the learning system described above, the human phantom may be provided with a camera capable of capturing the learner at a position of an eye portion for a human phantom having a head or at a position corresponding to an eye portion for a human phantom having no head.

With the learning system according to the present aspect, it is possible to capture a video at an eyeline of observing the learner during training (learning) simulating an examination or treatment, and obtain the video. That is, the learner can objectively observe the expressions and actions of the practitioner as viewed from the patient, etc., at the time of an actual operation. In addition, the learner can also feel the psychological state of the patient, etc., such as how the practitioner is viewed from the patient, etc. Accordingly, the learner can learn both the practitioner side and the patient side in one training session.

Note that the “camera” described above may be provided so as to be able to capture the learner. If, however, for example, the camera has a fixed structure, it is preferable that the angle of view is wide. In addition, the camera may have a movable structure. Examples of the movable structure include a structure in which a head or an eye portion (including a portion at a position corresponding to the eye portion) can be manually, automatically, or remotely operated to face the direction of the learner and capture the learner.

In addition, the video captured by the camera described above may be displayed in real time on the mixed reality display worn by the learner or may be recorded on a hard disk, etc., of a PC connected to the mixed reality display. The mode of displaying a video on the mixed reality display in real time may be, for example, a mode of displaying a video on a sub-window opened on a side of a video of the human phantom viewed by the learner or a mode of displaying a video on the entire screen by appropriately switching from the video of the human phantom viewed by the learner. In addition, in the case of the mode of recording data on a hard disk, etc., of a PC, for example, a learner, etc., can check the data on another monitor, etc., after training (learning). Furthermore, the captured video may be simultaneously output to a large monitor. In this case, a standby learner other than the learner who is being trained (learned) can also share the video, and the standby learner who starts the training next can easily understand the perspective and the state of mind on the patient side, so that the learning efficiency of the entire learner group can be expected to be improved.

Furthermore, in the learning system described above, the mixed reality display may be set so that a third virtual expansion which is an examination device and/or a therapy device model can be visualized in a superimposed manner in an indoor space where the human phantom is installed.

Note that the expression “examination device and/or therapy device” used in the present aspect includes both the examination device and the therapy device and only one of the examination device and the therapy device.

With the learning system according to the present aspect, by visually recognizing the third virtual expansion projected in the indoor space via the mixed reality display, the indoor space can be regarded as an examination room or a treatment room, and the human phantom installed therein can also be regarded as a subject to be examined, treated, etc., to perform learning. For example, while viewing the image of the third virtual expansion (examination device model, etc.) projected in the indoor space, the learner can perform learning or training of a preparation or check procedure, etc., of an examination device, etc., before the start and can also perform learning or training of the learner's maneuvers and movements according to the positions of the examination device and the human phantom after the start.

That is, with the learning method according to the present aspect, it is possible to perform training of a procedure of a medical operation or treatment to be performed as if the procedure or treatment is performed for a patient in a space where the actual examination device or therapy device exists without preparing an actual examination device or therapy device, and it is possible to expect an even higher learning effect by receiving a visual stimulus as if a learner is performing treatment, etc., on the patient, etc., in an actual site.

### Advantageous Effects of Invention

According to the learning method and the learning system of the present invention, a learner can learn a procedure of a medical operation or treatment to be performed by using a learning target tool with respect to a real human phantom while visually recognizing the virtual expansion of a physical anatomical model projected on the human phantom via a mounted mixed reality display.

### BRIEF DESCRIPTION OF DRAWINGS

FIG. 1 is a schematic diagram illustrating the configuration of a learning system according to a first embodiment of the present invention.

FIG. 2 is an image diagram illustrating a human phantom and a first virtual expansion projected on the human phantom in the learning system illustrated in FIG. 1.

FIGS. 3(a), 3(b) and 3(c) illustrate the learning system according to a second embodiment, in which FIG. 3(a) is a perspective view illustrating a state before the first virtual expansion and a second virtual expansion are projected on the human phantom, FIG. 3(b) is a perspective view illustrating a state in which the first virtual expansion and the second virtual expansion are projected on the human phantom, and FIG. 3(c) is a perspective view illustrating a state in which only a bone image is erased from the first virtual expansion projected in FIG. 3(b).

FIG. 4 is a front view illustrating a modification (Modification 5) of the learning system according to the second embodiment illustrated in FIG. 3, in which the first virtual expansion, the second virtual expansion (chest CT image), virtual operation buttons, etc., are projected on the human phantom.

FIGS. 5(a) and 5(b) are explanatory diagrams of a use state of the learning system illustrated in FIG. 4, in which FIG. 5(a) illustrates a state in which the display position of the second virtual expansion (chest CT cross-sectional image) projected on the human phantom is lowered to a substantially intermediate position in the chest height direction by operation and FIG. 5(b) illustrates a state in which the display position is further lowered than the position in FIG. 5(a) by operation.

FIGS. 6(a) and 6(b) are explanatory diagrams of a use state of the learning system illustrated in FIG. 4, in which FIG. 6(a) illustrates a state in which the display position of the second virtual expansion (chest CT coronal section image) projected on the human phantom is at a substantially intermediate position in the chest depth direction by operation and FIG. 6(b) illustrates a state in which the display position is located further to the deep side than the position in FIG. 6(a) by operation.

FIGS. 7(a) and 7(b) are explanatory diagrams of a use state of the learning system illustrated in FIG. 4, in which FIG. 7(a) illustrates a state in which the display position of the second virtual expansion (chest CT sagittal section image) projected on the human phantom is at a substantially intermediate position in the chest width direction by operation and FIG. 7(b) illustrates a state in which a three-dimensional anatomical image is simultaneously superimposed on the video of FIG. 7(a) by operation.

FIG. 8 is an explanatory diagram illustrating the configuration of the human phantom used in the learning system according to a third embodiment of the present invention.

FIG. 9 is an image diagram illustrating a third virtual expansion projected in a teaching room in the learning system according to a fourth embodiment of the present invention.

### DESCRIPTION OF EMBODIMENTS

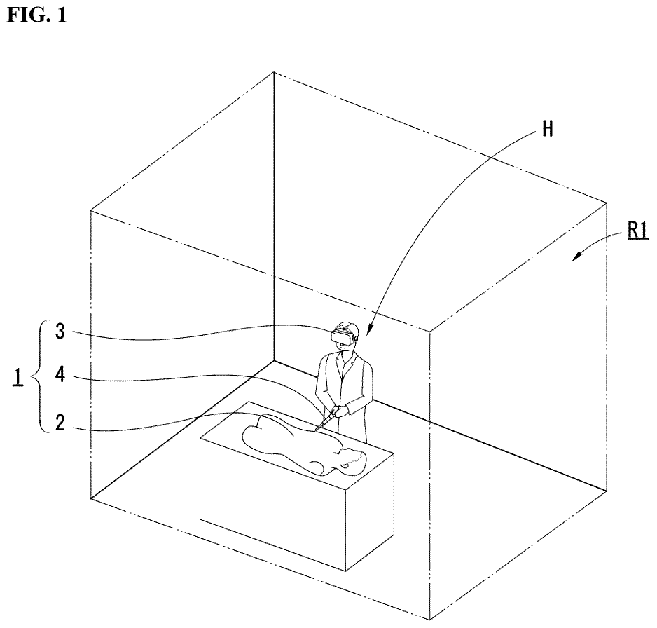

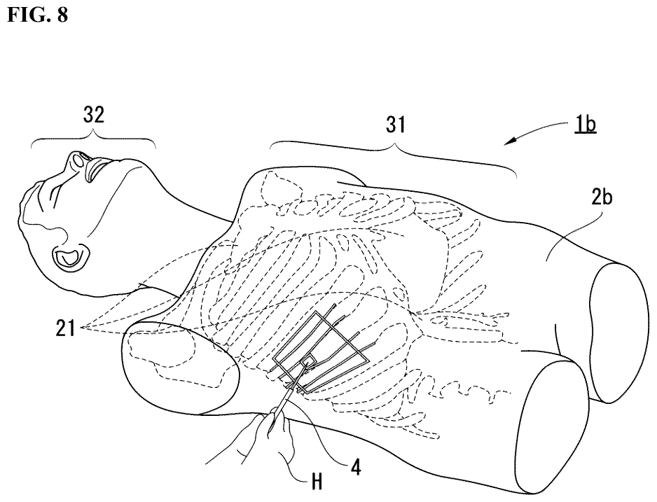

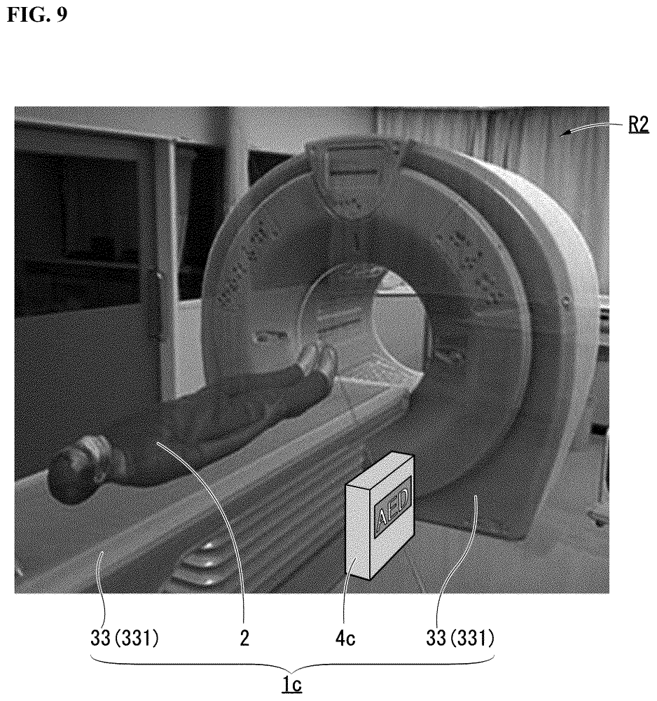

The embodiments of the present invention will be described in more detail with reference to FIGS. 1 to 9. The following description will be given in the order of the first embodiment, the second embodiment, the first modification, the second modification, the third modification, the fourth modification, the fifth modification, the third embodiment, and the fourth embodiment. In addition, reference numerals in the respective drawings are given within the range that reduces complexity and facilitates understanding, and reference numerals may be given to only some of a plurality of equivalents to which the same reference numerals are given.

### First Embodiment

### Learning System 1

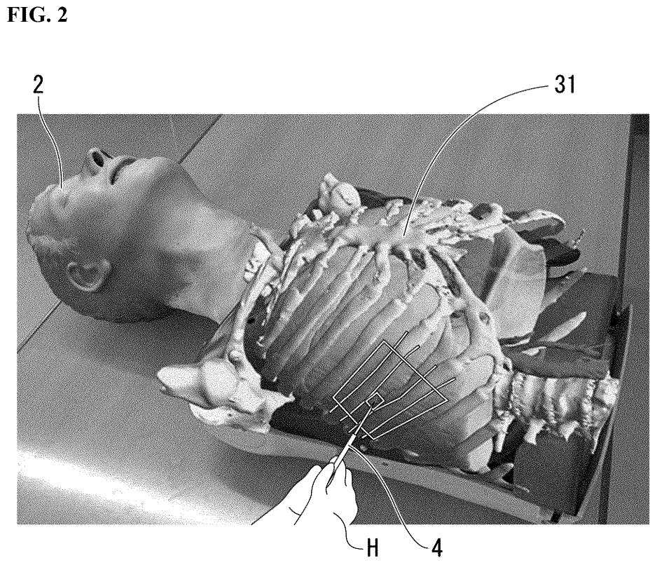

Reference is made to FIGS. 1 and 2. A learning system 1 used in a teaching room R1 includes a human phantom 2 to be projected, a mixed reality display 3 worn by a learner H, and a learning target tool 4 to be a medical operation learning target of the learner H. Each unit of the learning system 1 will be described in detail below.

### Human Phantom 2

The human phantom 2 can be a projection target of a first virtual expansion to be described later. In the present embodiment, the human phantom 2 is a full-size practical training model doll having a head and a torso, and a commercially available chest drain insertion simulator is used.

### Mixed Reality Display 3

The mixed reality display 3 is a device capable of superimposing and visualizing a first virtual expansion 31, which is a physical anatomical model, on a part or the whole of the human phantom 2, and is provided to be attachable to the head of the learner H. In the present embodiment, a head-mounted display (goggle type) capable of implementing the MR technology is used as the mixed reality display 3 (see FIG. 1).

In the present embodiment, the first virtual expansion 31 is images of the bones, organs, blood vessels, and trachea of a person, and data of these images installed in a storage function unit of the mixed reality display is constructed as an image in a mode (superimposed mode) in which a plurality of images are superimposed by an image generating function unit, and the image is projected via a display unit.

### Learning Target Tool 4

The learning target tool 4 is a medical operation learning target of the learner H and is a chest drain catheter and an inner cylinder (medical tool) in the present embodiment (see FIGS. 1 and 2).

### Operation of Learning System 1 and Learning Method Using the Same

An operation of the learning system 1 and a learning method using the same will be described with reference to FIGS. 1 and 2. The learning method includes at least the following first and second steps.

Specifically,
(1) In the first step, the learner H wears the mixed reality display 3 on his/her head, and visually recognizes the human phantom 2 and the first virtual expansion 31 projected on the human phantom 2 via the mixed reality display 3, and
(2) In the second step, the learner H who has performed the first step picks up the learning target tool 4 and applies the learning target tool 4 to the human phantom 2 while visually recognizing the human phantom 2 and the first virtual expansion 31, and learns a procedure of a medical operation or treatment to be performed.

An operation of the learning system 1 (and a learning method using the same) will be described. Note that, in the first step, before the learner H starts learning, an instructor (or the learner himself/herself) installs the human phantom 2 at an appropriate position (on a bed in FIG. 1), wears the mixed reality display 3, and performs setting so that the first virtual expansion 31 is correctly projected on the human phantom 2. According to the above setting, the instructor, etc., wearing the mixed reality display 3 operates the virtual controller appearing on the display to select the first virtual expansion 31 to be projected and adjusts a position, etc., for superimposing and visualizing the first virtual expansion 31 with respect to the human phantom 2.

By wearing the mixed reality display 3, the learner H can visually recognize the human phantom 2 and the first virtual expansion 31 projected the human phantom 2 via the mixed reality display 3. Then, when learning a procedure of a medical operation or treatment, the learner H can hold the learning target tool 4 used for an actual operation and apply the learning target tool 4 to the human phantom 2 on which the first virtual expansion 31 is projected.

As a result, the learner H visually obtains a realistic feeling and an immersive feeling as if facing a patient, etc., and applies the learning target tool 4 to the human phantom 2 by holding the actual learning target tool 4 instead of an intangible virtual image, so that a response close to actual work can be obtained tactilely. Accordingly, since the learner H receives visual and tactile stimuli as if a treatment, etc., is performed on a patient, etc., in an actual site, a high learning effect can be expected.

Note that, in the present embodiment, the human phantom 2 is only the head and the torso, but the mixed reality display 3 can project the first virtual expansion, which is the virtual upper limb or lower limb, etc., even on the non-physical portion the human phantom 2 three-dimensionally in a superimposed manner. This makes it possible to also visually recognize and learn the part of the body continuous with the part to be learned (added to the part to be learned).

Further, the mixed reality display 3 can switch between display and non-display of the non-physical portion as necessary. In addition, the mixed reality display 3 can also easily change the content of the first virtual expansion 31 to be projected by installing image data, and if various images and videos are projected on one human phantom, effects similar to those obtained by actually possessing a plurality of human phantoms can be obtained.

As a result, even if a plurality of types of human phantoms are not possessed, various kinds of learning can be performed by changing the content of the first virtual expansion 31 or switching between display and non-display of a non-physical portion. Accordingly, efficiency and the effect of learning can be improved. In addition, introduction (procurement) and operation costs associated with the possession of a plurality of human phantoms can also be reduced. Further, the storage space at the time of non-use of the human phantoms can also be reduced.

Furthermore, the first virtual expansion may use not only an image of a standard organ, etc., but also an image of an affected part, etc., of an individual patient collected in a previous examination, etc. In this case, before performing a treatment or surgery for a patient with a specific medical condition, it is possible to perform simulation training (learning) that is more case-specific and that incorporates visual sense and tactile sense, as compared with training using a general model. Furthermore, by installing or updating the data related to the first virtual expansion, it is possible to perform learning regarding examination of a new case or a special case and proficiency training of a new treatment method.

### Second Embodiment

### Learning System 1a

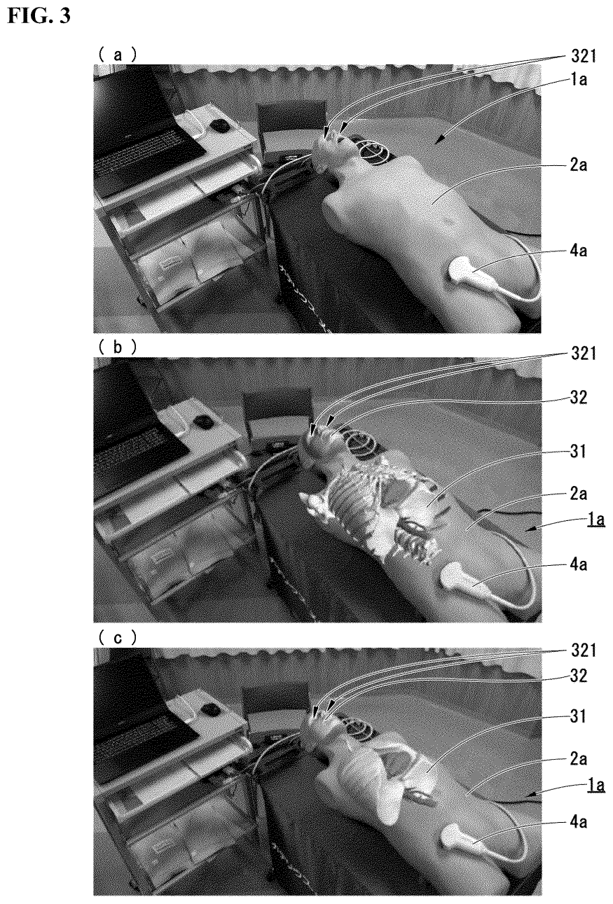

Reference is made to FIGS. 3(a), 3(b) and 3(c). A learning system la is another embodiment (second embodiment) of the learning system 1 and includes a human phantom 2a, a mixed reality display 3a, and a learning target tool 4a. Note that, since the learning system la is partially common in structure and function effect to the learning system 1 according to the first embodiment, descriptions of common structures and function effects will be omitted, and different structures and function effects will be described later. Note that, although illustration of the mixed reality display 3a is omitted in the description of the present embodiment, the mixed reality display according to the present embodiment is denoted by reference numeral “3a” for convenience of description of differences from the mixed reality display 3.

### Human Phantom 2a

The human phantom 2a can be a projection target of the first virtual expansion and a second virtual expansion to be described later. In the present embodiment, the human phantom 2a is a full-size practical training model doll having a head, a torso, and the upper half of the thighs (see FIG. 3(a); no mechanism such as a chest drain insertion portion is particularly provided).

### Mixed Reality Display 3a

The mixed reality display 3a is a head mounted display (goggle type) capable of implementing an MR technology, and in addition to the first virtual expansion 31 described above, a second virtual expansion 32, which is an expression model of the patient role, is set so as to be capable of being superimposed and visualized with respect to the face portion of the human phantom 2a (see FIG. 3(b) and 3(c)).

In the present embodiment, the second virtual expansion 32 is an image of the face of a person, and data of the image installed in the storage function unit of the mixed reality display is constructed as an image in a mode (superimposed mode) in which the image is superimposed on the face portion of the human phantom 2a by the image generating function unit, and the image is projected via the display unit.

### Learning Target Tool 4a

The learning target tool 4a is a medical operation learning target of a learner and includes an ultrasonic diagnostic apparatus and a probe (examination tool) thereof in the present embodiment (see FIGS. 3(a) to 3(c)).

According to the learning system 1a and the learning method using the same, in addition to the first virtual expansion 31, the second virtual expansion 32 is visualized (applied) in a superimposed manner with respect to the face portion of the human phantom 2a (see FIGS. 3(b) and 3(c)). As a result, the learner can learn while visually recognizing the expression model as needed projected as the second virtual expansion 32. Furthermore, according to the learning system 1a, it is possible not only to acquire a technique that is directly related to a case but also to perform training of observing a change in the expression of the patient (human phantom 2a) due to a sudden change in the disease state before the start of a medical operation or engaging in conversation for alleviating the anxiety or tension of the patient.

Then, according to the learning system 1a and the learning method using the same, it is possible to perform training of a procedure of a medical operation or treatment to be performed as if the procedure or treatment is performed for an actual patient without preparing an actual patient or a patient role, and it is possible to expect an even higher learning effect by receiving a visual stimulus as if a learner is performing treatment, etc., on the patient, etc., in an actual site.

### First Modification

The learning system 1a according to the first modification is set so as to be able to capture, as an expression model of the patient role expressed by the second virtual expansion 32, a face image of an educational guidance teacher or a fellow learner captured by the mixed reality display 3a or an external terminal, and display a real-time expression processed by the video processing software. In addition, the expression model and the learner are set to be able to converse with each other, allowing for training in adaptive responses.

Note that, the learning system la according to the first modification has the same structure and function effect as the learning system la of the second embodiment except for the above points, and thus, a description of the same structure and function effect is omitted, and the same reference numerals are also used for the reference numerals related to the learning system and the names of the respective units in a description of the differences. Although not illustrated, the learning system la according to the first modification will be described with the same reference numerals as those of the second embodiment.

According to the learning system 1a of the first modification and the learning method using the same, since the fellow learner is used as the expression model of the patient role, a sense of tension is provided in learning and a high learning effect can be expected (on the other hand, there is a possibility that a high learning effect can also be expected under a relaxed atmosphere by providing humor). Furthermore, according to the learning method using the learning system 1a of the first modification, it is possible to perform learning including training of visually recognizing the expression model of the patient role as needed and interacting through conversation (for example, explanation or chat for alleviating the anxiety or tension of a patient) according to the situation.

### Second Modification

In the learning system 1a according to the second modification, a pressure sensor (not illustrated) is provided in a torso of the human phantom 2a, and a position sensor (not illustrated) is provided in the tip portion of the learning target tool 4a. In addition, in the learning system 1a, the mixed reality display 3a has a reception function for the position information detected by a position sensor, a reception function capable of receiving the pressure value detected by the pressure sensor, and a set value storage function and is set such that the second virtual expansion 32 changes to an expression expressing discomfort or suffering when both or one of the position information and the pressure value received by the respective reception functions exceeds a preset set value.

Note that, the learning system 1a according to the second modification has the same structure and function effect as the learning system la of the second embodiment (and the first modification) except for the above points, and thus, a description of the same structure and function effect is omitted, and the same reference numerals are also used for the reference numerals related to the learning system and the names of the respective units in a description of the differences. Although not illustrated, the learning system la according to the second modification will be described with the same reference numerals as those of the second embodiment.

In training of ultrasonic examination (so-called echo examination) performed using the learning system la according to the second modification, when the learner H presses the probe against the abdomen, etc., of the human phantom 2a, the pressure value is transmitted by the pressure sensor provided in the human phantom 2a. The mixed reality display 3a receives the transmitted pressure value, and when the pressure value is inappropriate, the expression model represented by the second virtual expansion 32 displayed on the screen of the mixed reality display 3a changes to an expression expressing discomfort or suffering.

That is, according to the learning system 1a of the second modification and the learning method using the same, when the learning target tool 4a is applied to the human phantom 2a in the training which is arranged to simulate the examination described above, the expression model represented by the second virtual expansion 32 changes to an expression expressing discomfort or suffering in the case where the learner H performs an operation in a way that would cause pain if performed on an actual human. As a result, it is possible to immediately determine that an inappropriate operation has been performed by the learner H himself/herself, and it is also possible to perform training of an operation while checking the expression as if performing an operation on an actual person.

### Third Modification

In the learning system 1a according to the third modification, in the expression model (FIGS. 3(b) and 3(c)) visualized by the second virtual expansion 32, the eyeline is set to be movable in the direction of the learner H in a depiction related to the eye (an eye portion 321) in a timely manner, and the eyeline is also set to be recognizable by the learner H via the mixed reality display 3a.

Note that, the learning system 1a according to the third modification has the same structure and function effect as the learning system 1a of the second embodiment except for the above points, and thus, a description of the same structure and function effect is omitted, and the same reference numerals are also used for the reference numerals related to the learning system and the names of the respective units in a description of the differences. Although not illustrated, the learning system 1a according to the third modification will be described with the same reference numerals as those of the second embodiment.

With the learning system 1a according to the third modification and the learning method using the same, when the learner H performs learning while visually recognizing the expression model of the patient role as needed projected by the second virtual expansion 32, the eyeline of the patient role can be changed and the learner H can recognize the change. Note that an actual patient or a person who receives an examination may look at the face of the practitioner when feeling anxiety or pain, but with the learning system 1a according to the third modification and the learning method using the same, the eyeline of the visualized expression model moves in the direction of the learner H in a timely manner, so that the learner can feel a sense of tension and a sense of reality close to an actual operation, and further improvement of the learning effect can be expected.

The aforementioned eyeline movement can be performed automatically or manually. Examples of the automatic operation include a mode that is a typical operation set in advance in the mixed reality display and a mode that is set such that the eyeline moves in a timely manner in the direction of the learner when pressure is sensed at a predetermined part of the human phantom by the link between the pressure sensor, etc., provided on the human phantom and software, etc., of the mixed reality display. Examples of the manual operation include a mode in which an educational guidance teacher, etc., performs an operation of intentionally moving the eyeline.

### Fourth Modification

In the learning system 1a according to fourth modification, a camera (not illustrated) capable of capturing the learner H is provided at the position of the eye portion 321 on the head of the human phantom 2a. In addition, the camera is a fixed wide-angle camera, and the human phantom 2a has a structure in which the head moves horizontally and vertically. Here, the video captured by the camera can be displayed in real time on the mixed reality display 3 worn by the learner H and can be recorded on a hard disk, etc., of a PC wirelessly connected to the mixed reality display 3.

Note that, the learning system 1a according to the fourth modification has the same structure and function effect as the learning system 1a of the second embodiment except for the above points, and thus, a description of the same structure and function effect is omitted, and the same reference numerals are also used for the reference numerals related to the learning system and the names of the respective units in a description of the differences. Although not illustrated, the learning system 1a according to the fourth modification will be described with the same reference numerals as those of the second embodiment.

With the learning system 1a according to the fourth modification and the learning method using the same, it is possible to capture a video at an eyeline observing the learner H during training (learning) simulating examination or treatment and obtain the video in real time, and it is also possible for the learner, etc., to check the video recorded on the hard disk, etc., of the PC after the training (learning) with another monitor, etc. That is, the learner H can objectively observe the expressions and actions of the practitioner as viewed from the patient, etc., at the time of an actual operation. In addition, the learner H can also feel the psychological state of the patient, etc., such as how the practitioner is viewed from the patient, etc. Accordingly, the learner H can learn both the practitioner side and the patient side in one training session.

Furthermore, the captured video may be simultaneously output to a large monitor. In this case, a standby learner other than the learner who is being trained (learned) can also share the video, and the standby learner who starts the training next can easily understand the perspective and the state of mind on the patient side, so that the learning efficiency of the entire learner group can be expected to be improved.

In the present modification, the above-described “camera” has the above-described structure but is not limited thereto and may be provided to be able to capture a learner, such as a movable structure. In addition, in a case where the human phantom does not have a head, a camera capable of capturing the learner may be provided at a position corresponding to the eye portion. Furthermore, in a case where the stereo camera is installed as the camera, and another learner in the role of a patient wears the mixed reality display and observes the video, it is thus possible to immerse in the environment at the eyeline of the patient role, etc., which has a stereoscopic effect and to even feel the psychological state of the patient, etc.

### Fifth Modification

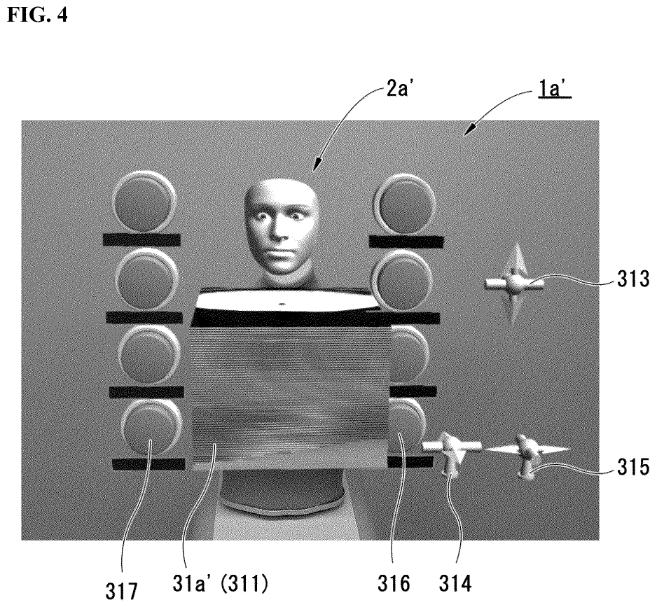

A learning system 1a′ according to the fifth modification illustrated in FIGS. 4 to 7 uses a human phantom 2a′ (with no head, only torso) and is configured such that a two-dimensional CT image 311 of an organ set to an appropriate size fitted to the human phantom 2a (equivalent to the above “medical image;” the same applies hereinafter) and a three-dimensional anatomical image 312, which serve as a first virtual expansion 31a′ to be applied to the human phantom, are provided so as to be superimposed on the same screen. FIGS. 4 to 7 illustrate an entire video displayed on the mixed reality display 3a in the learning system 1a′, and the learner H visually recognizes the video.

Reference is made to FIG. 4. The first virtual expansion 31a′ illustrated in FIG. 4 is the two-dimensional CT image 311 of the chest (obtained by superimposing a large number of chest CT cross-sectional images). Then, a plurality of handles (three in the present modification) and a plurality of buttons (eight in the present modification) expressed by virtual expansion are displayed around the human phantom 2a′. Each handle described above is used to change the display position, etc., of the image, and the learner H grips the handle on the display screen and performs an operation. In addition, each of the buttons described above is used for switching display of an image, etc., and the learner H presses the button on the display screen to perform an operation.

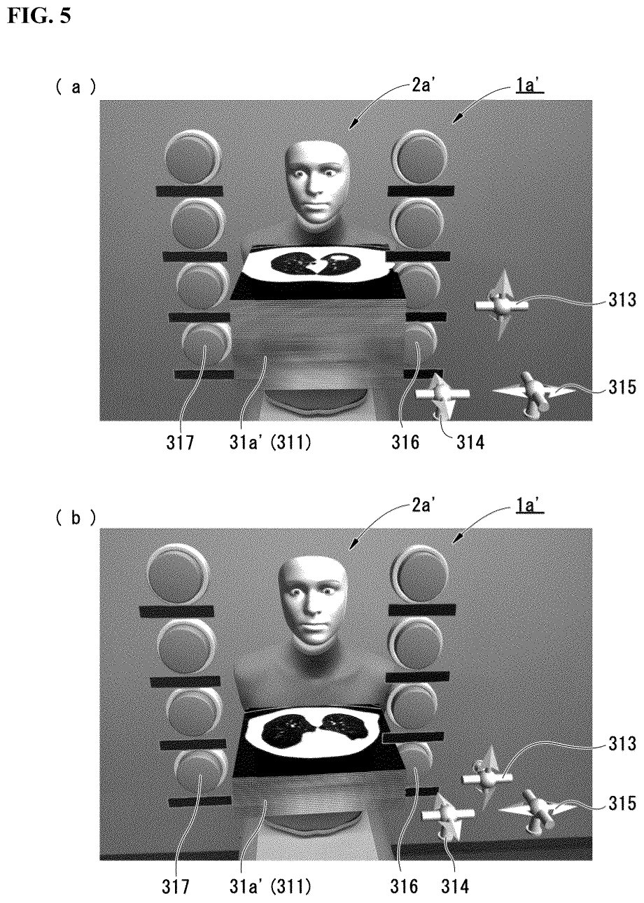

In the learning system 1a′, the learner H grips a first handle 313 in the displayed video and moves the first handle in the vertical direction of the video, so that the chest CT cross-sectional image at an arbitrary position can be displayed. For example, when the learner H grips the first handle 313 and lowers the position of the first handle 313 illustrated in FIG. 4 downward, the displayed position of the chest CT cross-sectional image gradually descends as illustrated in FIGS. 5(a) and 5(b). Note that, conversely, when the gripped first handle 313 is raised, the position of the chest CT cross-sectional image gradually rises (not illustrated). That is, the lifting/lowering operation of the first handle 313 and the display position in the chest CT cross-sectional image are interlocked.

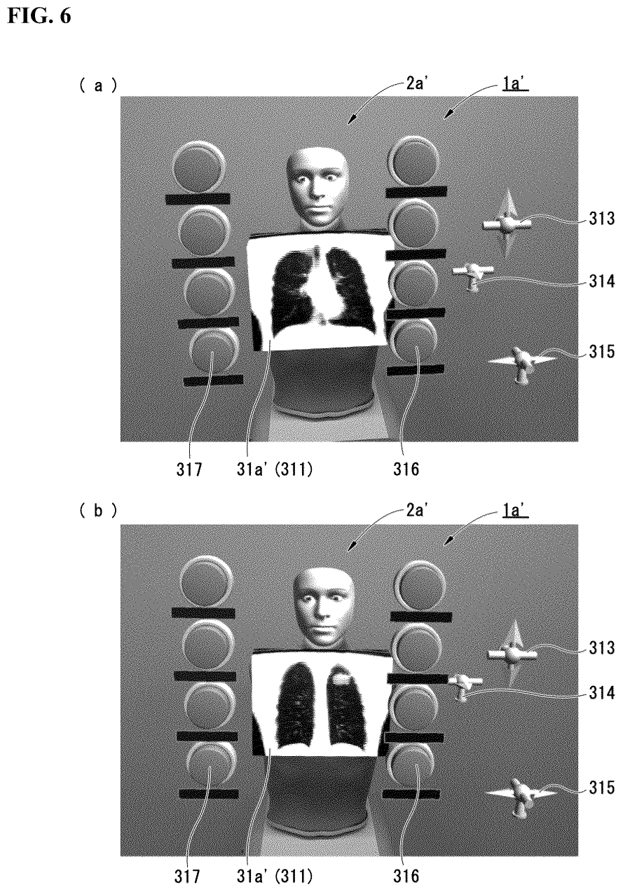

In addition, in the learning system 1a′, the learner H grips a second handle 314 in the displayed video and moves the second handle 314 in the front-back direction of the video, so that the chest CT coronal section image at an arbitrary position can be displayed. For example, when the learner H grips the second handle 314 and pushes the second handle 314 in the depth direction of the displayed image from the position of the first handle 313 illustrated in FIGS. 6(a) and 6(b), the position of the chest CT coronal section image displayed as illustrated in FIGS. 6(a) and 6(b) gradually moves to the depth side. Note that, conversely, when the gripped second handle 314 is drawn in the front direction, the position of the chest CT coronal section image gradually moves to the front side (not illustrated). That is, the front-back moving operation of the second handle 314 and the display position in the chest CT coronal section image are interlocked.

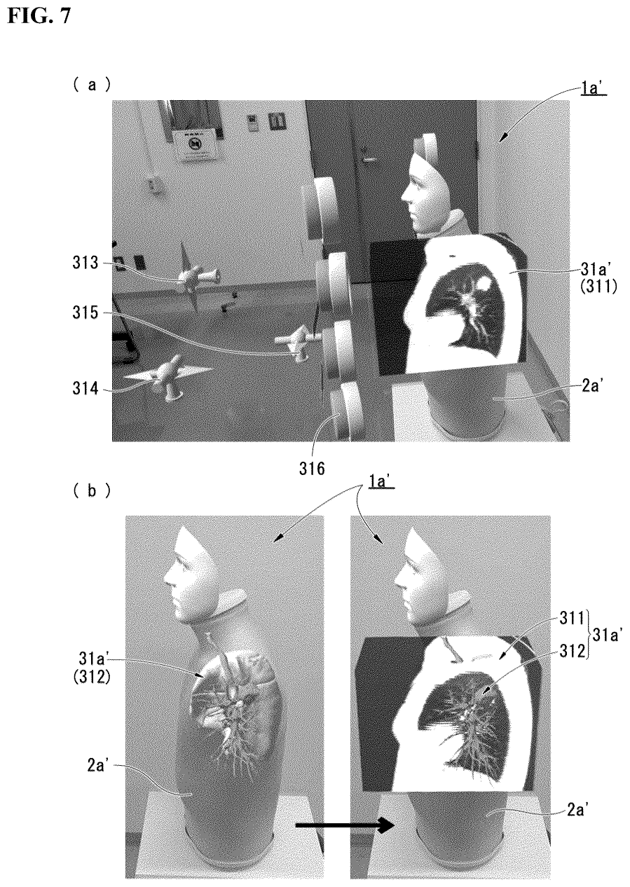

Furthermore, in the learning system 1a′, the learner H grips a third handle 315 in the displayed video and moves the third handle 315 in the left-right direction (left-right direction in FIGS. 4 to 6, and the front-back direction in FIG. 7(a)) of the video, so that the chest CT sagittal section image at an arbitrary position can be displayed. For example, when the learner H grips the third handle 315 and pushes the third handle 315 in the depth direction of the displayed video from the position of the third handle 315 illustrated in FIG. 7(a), the position of the displayed chest CT sagittal section image gradually moves to the depth side. Note that, conversely, when the gripped third handle 315 is drawn in the front direction, the position of the chest CT sagittal section image gradually moves to the front side (not illustrated). That is, the front-back (left-right) moving operation of the third handle 315 and the display position in the chest CT sagittal section image are interlocked.

A first button 316 is a display ON/OFF switch of the two-dimensional CT image 311. When the learner H presses the first button 316 (turns on the switch) in the displayed video, the learning system 1a′ can display the two-dimensional CT image 311 (the two-dimensional CT image of the chest in FIGS. 4 to 7(a)) (project the two-dimensional CT image 311 on the human phantom 2a′ in a superimposed manner).

A second button 317 is a display ON/OFF switch of the three-dimensional anatomical image 312. When the learner H presses the second button 317 (turns on the switch) in the displayed video, the learning system 1a′ can display the three-dimensional anatomical image 312 (the three-dimensional anatomical image of the chest in FIG. 7(b)) (project the three-dimensional anatomical image 312 on the human phantom 2a′ in a superimposed manner).

By alternately pressing the first button 316 and the second button 317, the videos shown in FIGS. 7(a) and 7(b) can be alternately displayed. That is, with the learning system 1a′ according to the fifth modification and the learning method using the same, the learner H can learn while visually recognizing the stereoscopic full-size two-dimensional CT image 311 and the three-dimensional anatomical image 312 superimposed and projected by the first virtual expansion 31a′ as needed, and eventually, can learn the spatial positional relationship the two-dimensional CT image 311 and the three-dimensional anatomical image 312 in association with the two dimensions and the three dimensions.

As a result, it is possible to perform training for understanding the relationship between the two-dimensional CT image and the three-dimensional anatomical image, with which many students and inexperienced practitioners have been struggling and to further deepen understanding. This makes it possible to expect further improvement of a learning effect. Then, the understanding of the relationship between the two-dimensional CT image and the three-dimensional anatomical image by the learner H is deepened, and hence it is expected that the learner H will eventually be able to intuitively understand the position of the organ, etc., only by viewing the two-dimensional CT image.

In the learning system 1a′ according to the fifth modification, examples of the two-dimensional CT image 311 and the three-dimensional anatomical image 312 include a mode which is a healthy standard image, a mode which is an image of an organ, a bone, etc., of a patient or an individual having a lesion or a specific feature, etc. Then, in a case where an image of an organ, a bone, etc., of a patient having a lesion is applied, not only the learner but also a medical worker including a doctor can use the image for consideration of an operation plan before actual surgery or treatment or for a pre-operative meeting.

“The two-dimensional CT image and the three-dimensional anatomical image can be superimposed on the same screen” means that the two-dimensional CT image and the three-dimensional anatomical image only need to be superimposed on the same screen and includes both a mode in which the two-dimensional CT image and the three-dimensional anatomical image are alternately displayed at the same position by switching and a mode in which the two-dimensional CT image and the three-dimensional anatomical image are simultaneously overlapped and displayed.

### Third Embodiment

### Learning System 1b

Reference is made to FIG. 4. A learning system 1b is another embodiment (third embodiment) of the learning system 1 and includes a human phantom 2b, the mixed reality display 3, and the learning target tool 4. Note that, in the learning system 1b, the structures and function effects of the mixed reality display 3 and the learning target tool 4 are common to those of the learning system 1 according to the first embodiment, and thus, descriptions of the common structures and function effects will be omitted, and the structure and function effect of the different human phantom 2b will be described later. Furthermore, in the description of the present embodiment, although illustration of the mixed reality display m is omitted, the mixed reality display is denoted by reference numeral “3” for convenience of description.

### Human Phantom 2b

The human phantom 2b can be a projection target of the first virtual expansion 31 and the second virtual expansion 32 (see FIG. 4). In the present embodiment, the human phantom 2b is a full-size practical training model doll having a head, a torso, and the upper half of the thighs, and a cavity is formed in the chest of the human phantom 2b, and a pseudo structure 21 (see the broken line portion in FIG. 4) reproducing the arrangement, shapes, and textures of skin, muscle, bone, pleura, lung, and blood vessel is applied to the cavity. In the pseudo structure 21, skin, muscles, pleura, lungs, and blood vessels are formed of a soft material, and bones are formed of a hard material. Note that the pseudo structure may be assembled by purchasing a model (ready-made product) of an individual organ, etc., or may be independently manufactured using a 3D printer as described later.

When the pseudo structure is internally manufactured, examples of manufacturing methods of the pseudo structure include a mode in which the pseudo structure is manufactured using a 3D printer, and a mode in which the pseudo structure is assembled using a resin-based film material (wrap), a foamed resin material (sponge), various hard and soft resin materials, or a combination thereof. Furthermore, the internally or externally manufactured pseudo structure may be not only a standard organ but also a reproduction of an organ, etc., of an individual patient collected in a previous examination, etc. In this case, before performing a surgery for a patient with a specific medical condition, it is possible to perform simulation training that is more case-specific and that incorporates visual sense and tactile sense, as compared with training using a general model.

According to the learning system 1b and the learning method using the same, when the learning target tool 4 is applied to the human phantom 2b in training of a medical operation, since the pseudo structure 21 reproducing the shape, etc., and the hardness of a part to be treated such as skin is applied, a response closer to the human body can be obtained tactilely. As a result, the learner H receives a tactile stimulus as if a treatment, etc., is performed on a patient, etc., in an actual site and can expect a higher learning effect.

Furthermore, in the learning system 1b, since the human phantom 2b has the structure including the pseudo structure 21 in which each element is provided in a superimposed manner, in the training of the operation of puncturing the target organ as illustrated in FIG. 4 (that is, in using the learning target tool 4), the learner H can learn the medical operation by the tactile sensation close to the actual human body, such as palpation of a space between bones, the degree of force passing through the skin, membrane, or muscle while feeling the resistance at the time of puncture, the operation of penetrating the space between the bones without damaging the muscle fibers or the blood vessels with a needle, and the adjustment of force or depth of bringing the needle to the target organ.

Note that the image projected by the first virtual expansion 31 is set to be projected at a position overlapping with the equivalent in the pseudo structure 21, and for example, the image of the bone portion of the pseudo structure 21 and the image of the bone projected by the first virtual expansion 31 are projected at the overlapping position. As a result, the learner can visually recognize the projected distribution of the blood vessels, etc., and arrangement of the Organ and the bones (first virtual expansion 31) via the mixed reality display 3 and can also visually recognize the projected expression model (the second virtual expansion 32), and thus, it goes without saying that learning through vision is also possible (however, in FIG. 4, the configuration of the pseudo structure 21 is emphasized for easy understanding, and the image projected by the first virtual expansion 31 as illustrated in FIG. 2 is omitted, and only the position is illustrated.).

### Fourth Embodiment

### Learning System 1c

Reference is made to FIGS. 5(a) and 5(b). A learning system 1c is another embodiment (fourth embodiment) of the learning system 1 and includes the human phantom 2, a mixed reality display 3c, and a learning target tool 4c. Note that, in the learning system 1c, since the structure and the function effect of the human phantom 2 are common to those of the learning system 1 according to the first embodiment, descriptions of common structures and function effects will be omitted, and the different structures and function effects of the mixed reality display 3c and the learning target tool 4c will be described later. In addition, although illustration of the mixed reality display 3c is omitted in the description of the present embodiment, the mixed reality display according to the present embodiment is denoted by reference numeral “3c” for convenience of description of differences from the mixed reality display 3.

### Mixed Reality Display 3c

The mixed reality display 3c is a head mounted display (goggle type) capable of implementing the MR technology, and in addition to the first virtual expansion 31 and the second virtual expansion 32 described above, a third virtual expansion 33, which is an examination device (a CT examination device in the present embodiment), is set so as to be capable of being superimposed and visualized with respect to a teaching room R2, which is an indoor space in which the human phantom 2 is installed (see FIGS. 5(a) and 5(b)).

In the present embodiment, the third virtual expansion 33 is an image of an examination device 331, and the data of the image installed in the storage function unit of the mixed reality display is constructed as an image in a mode (superimposed mode) in which the image is superimposed on the indoor space of the teaching room R2 by the image generating function unit, and the image is projected via the display unit. Note that, in the image of the examination device 331, the gantry portion is projected in an empty space, and the cradle portion is projected to be superimposed on a general bed on which the human phantom 2 is placed.

### Learning Target Tool 4c

The learning target tool 4c is an automated external defibrillator (AED).

According to the learning system 1c and the learning method using the same, the learner visually recognizes the third virtual expansion 33 projected in the space in the teaching room R2 via the mixed reality display 3c, so that the teaching room R2 can be regarded as the examination room, and the human phantom 2 (projecting the first virtual expansion 31 and the second virtual expansion 32) installed therein can also be regarded as the subject to be examined to perform learning (see FIGS. 5(a) and 5(b)). Then, while viewing the image of the third virtual expansion 33, the learner can perform learning and training of preparation, a check procedure, etc., of the examination device 331 before the start and can also perform learning and training of the learner's maneuvers and other movements according to the positions of the examination device 331 and the human phantom 2 after the start.

By the way, since a contrast medium is used in a CT examination, there is a possibility that the examination subject will develop a medication-induced shock. However, according to the learning system 1c and the learning method using the same, it is possible to perform resuscitation training using the learning target tool 4c (AED) on the human phantom 2 on the assumption of onset. In other words, the learning system 1c enables simulation for reproducing a special environment in the teaching room R2 and coping with a situation that may occur under the environment.

That is, according to the learning system 1c and the learning method using the same, it is possible to perform training of a procedure of a medical operation or treatment to be performed as if the procedure or treatment is performed for a patient in a space where the actual examination device exists without preparing an actual examination device, and it is possible to expect an even higher learning effect by receiving a visual stimulus as if a learner is performing treatment, etc., on the patient, etc., in an actual site. In addition, according to the learning system 1c and the learning method using the same, it is possible to facilitate a simulated experience as if there is a virtual examination device in a case where there is no actual examination device, and it is also expected that a learner can become accustomed to the surrounding environment (examination room or operation room).

According to each of the learning systems 1 (1a, 1a′, 1b, or 1c) described above, the external output of the mixed reality display may be used to project the video viewed by the learner H on another display, and the experience of the viewpoint, situation, etc., of the learner H (success example, failure example, etc.,) may be shared with another student. Furthermore, the instructor can also give guidance or instruction to the student who is learning while looking at other displays.

Note that the conventional medical simulator is positioned as a tool for learning and acquiring a procedure and a medical operation of a medical practice, but each of the learning systems 1 (1a, 1a′, 1b, and 1c) described above and a learning method using the same focuses on learning regarding the risk, safety, and medical safety of medical operations, which cannot be performed by the conventional medical simulator.

In addition, with respect to various types of virtual expansion displayed on the mixed reality display 3 (3a and 3c), it is also possible to add a function of displaying, as a message, the region to be treated and whether the instrument to be selected is correct or incorrect in a superimposed manner on the region or the tool, for a specific disease or symptom. For example, there is a function of pop-up display of a character such as “correct” when an appropriate puncture site or range is touched, which improves the self-learning effect.

Furthermore, the first virtual expansion 31 and the second virtual expansion 32 displayed on the mixed reality display 3 (3a or 3c) in each of the learning systems 1 (1a, 1a′, 1b, and 1c) described above can select and project various expressions and body shapes of old and young men and women from preset data. As a result, it is possible to perform more practical learning while visually recognizing differences in body shape, organ, etc., depending on age and gender. In addition, since it is not necessary to prepare human phantoms having different ages, genders, and body shapes at the time of performing learning, introduction (procurement) and operation costs associated with the possession of a plurality of human phantoms can be reduced, and a storage space at the time of non-use can also be reduced.

In addition, according to each of the learning systems 1 (1a, 1a′, 1b, and 1c) described above, students (including practicing technicians and doctors) will eventually be able to intuitively learn three-dimensional images (also used for learning without medical operation training). Even a doctor, a medical radiologist, or a clinical laboratory technician can learn physical anatomy through vision according to each of the learning systems 1 (1a, 1a′, 1b, and 1c) described above although it is not easy to replace a two-dimensional image with a three-dimensional image in the brain unless they gain much experience (unless they see many images).

According to each of the learning systems 1 (1a, 1a′, 1b, and 1c) described above, it is also possible to learn anatomical or clinical rare cases. In surgical medical operations in clinical settings, medical accidents may occur due to encounter with anatomical or clinical rare cases, leading to patient death in some case reports. For example, a case in which the distribution of blood vessels is different from the dissection of a general person, a case in which the existence of a blood vessels itself is unique, etc., are exemplified. In such a case, there is also a possibility that the blood vessels are damaged at the time of treatment due to lack of knowledge and experience of an operator, leading to a serious medical accident.

However, according to each of the learning systems 1 (1a, 1a′, 1b, and 1c), since the display and non-display of the three-dimensional anatomical image can be selected, it is also possible to reproduce and display and learn the anatomical or clinical rare cases, and it is also possible to utilize the learning systems regarding the risk, safety, and medical safety of a medical operation in rare cases as described above.

In addition, according to each of the learning systems 1a, 1a′, 1b, and 1c described above, it is possible to reproduce and display a change in the line of sight of the face of the patient, etc., as the second virtual expansion, and thus, the sense of reality (in particular, a sense of tension) of the learner as an operator is increased by the line H sight of the patient, etc., facing the operator side, and further improvement of the learning effect can be expected.

Furthermore, in daily medical practice, observation of a two-dimensional CT image in full size is not performed, and currently, there is no environment in which a two-dimensional CT image and a three-dimensional anatomical image can be learned in full size and stereoscopically, and a simulator capable of simultaneously superimposing a two-dimensional CT image and a three-dimensional anatomical image in full size on a simulator and learning a spatial positional relationship thereof in association with two dimensions and three dimensions has not been found so far. However, according to each of the learning systems 1a, 1a′, 1b, and 1c described above, it is possible to simultaneously superimpose a two-dimensional CT image and a three-dimensional anatomical image in full size on a human phantom (simulator). With this function, it is possible to strongly support understanding of the relationship between the two-dimensional CT image and the three-dimensional anatomical image, which many learners struggle with, and training for understanding.

Then, according to each of the learning systems described above, a human phantom (simulator) which is a machine or a tool is further anthropomorphized and used. In particular, according to each of the learning systems 1a, 1a′, 1b, and 1c, bidirectionality (interactivity) based on the above-described function effects is added. Conventionally, there is no learning system using an anthropomorphized bidirectional human phantom, etc. However, according to a learning method using each of the learning systems 1a, 1a′, 1b, and 1c, an efficient and excellent learning effect can be expected as compared with learning using a conventional human phantom, etc.

The terms and expressions used in the present specification and claims are for the purpose of description only and are not intended to be limiting in any way, and are not intended to exclude terms or expressions equivalent to the features described in the present specification and claims and parts thereof. Furthermore, it goes without saying that various modifications are possible within the scope of the technical idea of the present invention. In addition, the terms “first,” “second,” etc., do not mean rank or importance, but are used to distinguish one element from another element.

### Reference Signs List

1, 1a, 1a′, 1b, 1c learning system
2, 2a, 2a′, 2b human phantom
21 pseudo structure
3, 3a, 3c mixed reality display
31, 31a′ first virtual expansion
311 two-dimensional CT image
312 three-dimensional anatomical image
313 first handle
314 second handle
315 third handle
316 first button
317 second button
32 second virtual expansion
321 eye portion
33 third virtual expansion
331 examination device
4, 4a, 4c learning target tool
H learner
R1, R2 teaching room

1. A learning method that is performed by using a human phantom to be projected, a mixed reality display capable of superimposing and visualizing a first virtual expansion that is a physical anatomical model on a part or all of the human phantom, and a learning target tool that is a medical tool or an examination tool as a medical operation learning target, the method comprising:
a first step of causing a learner to wear the mixed reality display and visually recognize the human phantom and the first virtual expansion projected on the human phantom via the mixed reality display; and
a second step of causing the learner who has undergone the first step to take the learning target tool by hand and apply the learning target tool to the human phantom while visually recognizing the human phantom and the first virtual expansion and learn a procedure of a medical operation or treatment to be performed.

2. The learning method according to claim 1, wherein the mixed reality display is capable of superimposing and visualizing a second virtual expansion that is an expression model of a patient role with respect to a face portion of the human phantom,
in the first step and the second step, the second virtual expansion is applied to the human phantom, and
at least in the second step, the learner performs learning while visually recognizing the expression model of the patient role projected by the second virtual expansion as needed or performs learning while visually recognizing the expression model of the patient role as needed and also engaging in conversation according to a situation.

3. The learning method according to claim 2, wherein in the expression model visualized by the second virtual expansion, an eyeline is set to be movable in a direction of the learner in a timely manner of at least a depiction related to an eye, and the eyeline is set to be recognizable by the learner via the mixed reality display.

4. The learning method according to claim 1, wherein the first virtual expansion is provided so that a medical image and a three-dimensional anatomical image which are set to appropriate sizes to be fitted to the human phantom are superimposed on the same screen.

5. The learning method according to claim 1, wherein the human phantom is applied to a pseudo structure in which any one of skin, muscle, bone, blood vessel, membrane, and organ is reproduced to at least a predetermined portion to be learned, or is applied to a plurality of these pseudo structures in combination.

6. The learning method according to claim 5, wherein the pseudo structure uses a soft material for skin, muscles, blood vessels, membranes, and organs and uses a semi-hard material or a hard material for bones.

7. The learning method according to claim 2, wherein the human phantom and the learning target tool are provided with a position sensor and a pressure-sensitive sensor or a pressure sensor, and the second virtual expansion is set to change to an expression expressing discomfort or suffering when both or any one of position information detected by the position sensor and a pressure value detected by the pressure-sensitive sensor or the pressure sensor exceeds a preset set value.

8. The learning method according to claim 1, wherein the human phantom is provided with a camera capable of capturing the learner at a position of an eye portion for a human phantom having a head or at a position corresponding to an eye portion for a human phantom having no head.

9. The learning method according to claim 1, wherein the human phantom is installed in an indoor space available as a teaching room, the mixed reality display is capable of superimposing and visualizing a third virtual expansion that is an examination device and/or a therapy device model in the indoor space, and
in both or one of the first step and the second step, the learner learns a treatment or procedure to be performed while visually recognizing the third virtual expansion projected in the indoor space via the mixed reality display.

10. A learning system comprising:
a human phantom to be projected;
a mixed reality display capable of superimposing and visualizing a first virtual expansion that is a physical anatomical model on a part or all of the human phantom and attachable to a head of the learner; and
a learning target tool that is a medical tool or an examination tool as a medical operation learning target.

11. The learning system according to claim 10, wherein the mixed reality display is set so that a second virtual expansion which is an expression model of a patient role is visualized in a superimposed manner with respect to a face portion of the human phantom.

12. The learning system according to claim 11, wherein in the expression model visualized by the second virtual expansion, an eyeline is set to be movable in a direction of the learner in a timely manner of at least a depiction related to an eye, and the eyeline is set to be recognizable by the learner via the mixed reality display.

13. The learning system according to claim 10, wherein the first virtual expansion is provided so that a medical image and a three-dimensional anatomical image which are set to appropriate sizes to be fitted to the human phantom are superimposed on the same screen.

14. The learning system according to claim 11, wherein the human phantom and the learning target tool are provided with a position sensor and a pressure-sensitive sensor or a pressure sensor, and the mixed reality display has a reception function capable of receiving position information detected by the position sensor and a pressure value detected by the pressure-sensitive sensor or the pressure sensor and a set value storage function, and is set such that the second virtual expansion changes to an expression expressing discomfort or suffering when both or one of the position information and the pressure value received by the reception function exceeds a preset set value.

15. The learning system according to claim 10, wherein the human phantom is applied to a pseudo structure in which any one of skin, muscle, bone, blood vessel, membrane, and organ is reproduced to at least a predetermined portion to be learned, or is applied to a plurality of these pseudo structures in combination.

16. The learning system according to claim 15, wherein the pseudo structure uses a soft material for skin, muscles, blood vessels, membranes, and organs and uses a semi-hard material or a hard material for bones.

17. The learning system according to claim 10, wherein the human phantom is provided with a camera capable of capturing the learner at a position of an eye portion for a human phantom having a head or at a position corresponding to an eye portion for a human phantom having no head.

18. The learning system according to claim 10, wherein the mixed reality display is set so that a third virtual expansion which is an examination device and/or a therapy device model is visualized in a superimposed manner in an indoor space where the human phantom is installed.
